(19) United States
(12) Patent Application Publication
(10) Pub. No.: US 2010/0014191 A1
(43) Pub. Date: Jan. 21, 2010

(54) PERPENDICULAR MAGNETIC RECORDING MEDIUM AND MAGNETIC RECORDING/REPRODUCTION APPARATUS

(75) Inventor: Hiroshi KANAZAWA, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/501,030

(22) Filed: Jul. 10, 2009

(30) Foreign Application Priority Data
Jul. 16, 2008 (JP) 2008-184499

(51) Int. Cl. G11B 5/127; G11B 5/66

(52) U.S. Cl. 360/110; 428/827; G9B/5.241; G9B/5.04

(57) ABSTRACT

This invention provides a perpendicular magnetic recording medium which has magnetic layers of a stabilized laminated structure and excels in the recording and reproducing property.

The perpendicular magnetic recording medium of this invention comprises at least an underlayer, a seed layer, a first intermediate layer, a second intermediate layer, a first magnetic recording layer, a second magnetic recording layer, and a protecting layer laminated in the order mentioned on a nonmagnetic substrate. The first intermediate layer is formed of an alloy having Ru as a main constituent and the second intermediate layer is formed of a CoCr alloy containing no Ru.

An alloy layer of a composition having Ru element as an essential constituent is sandwiched between the first magnetic recording layer and the second magnetic recording layer. Further, the first magnetic recording layer is formed of a magnetic alloy containing Ru.

### TECHNICAL FIELD

This invention relates to a perpendicular magnetic recording medium and a magnetic recording and reproducing apparatus that uses the perpendicular magnetic recording medium.

### BACKGROUND ART

In recent years, the ranges of application of such magnetic recording apparatuses as magnetic disk devices, flexible disk devices, and magnetic tape devices have been being notably expanded. In proportion to such growth of the importance of the magnetic recording apparatuses, the magnetic recording mediums that are used in these apparatuses have also been encouraging efforts directed toward conspicuous enhancement of recording density. Particularly since the introduction of the technologies concerning the MR head (magnetoresistive head) and the PRML (partial response maximum likelihood) signal processing, the surface recording density has further increased rapidly. In recent years, this increase has been continuing at a pace as high as about 30-40% per year owing to the further introduction of the GMR head (giant magneto resistive head), the TMR head (tunneling magneto resistive head), etc, as a contributory factor.

The magnetic recording mediums mentioned above are being required to attain still higher recording density in the future and, therefore, the magnetic recording layers are being required to attain further increases in coercive force, signal to noise ratio (SNR), and resolution. In the case of the longitudinal magnetic recording method which has been widely used to date, since the action of self-demagnetization that tends to weaken the mutual magnetization of the recording domains adjoining both sides of the magnetization transitional region becomes dominant in proportion to the increase in line recording density, the method is necessitated, for the purpose of avoiding the action mentioned above, to exalt the shape magnetic anisotropy by forming the magnetic recording layer in a still smaller thickness.

Meantime, as the magnetic recording layer has the film thickness thereof gradually decrease, the phenomenon of thermal fluctuation, namely the phenomenon in which the magnetization of the magnetic domain is relaxed because the magnitude of the energy barrier serving to retain the magnetic domain and the magnitude of the thermal energy approach the same level and the quantity of recorded magnetization is decreased by the influence of temperature, becomes no longer ignorable. This phenomenon is reputed to decide the limit of the line recording density.

Thus, the recent magnetic recording mediums have been adopting the perpendicular magnetic recording technology. In contrast to the conventional longitudinal magnetic recording method that magnetizes a medium in the in-plane direction, the perpendicular magnetic recording method is characterized by magnetizing a medium in the direction perpendicular to the plane of the medium. Owing to this characteristic, the perpendicular magnetic recording method is thought to be not only capable of avoiding the influence of the action of self-demagnetization which prevents the longitudinal magnetic recording method from accomplishing a high line recording density but also suitable for recording with still higher density. Further, the perpendicular magnetic recording method is thought to suffer rather insignificantly from the influence of the thermal magnetic relaxation that poses a problem for the longitudinal magnetic recording.

The perpendicular magnetic recording medium generally has a seed layer, an intermediate layer, a magnetic recording layer, and a protecting layer laminated sequentially on a non-magnetic substrate. More often than not, the protecting layer has the surface thereof coated with a lubricating layer. Then, most of the perpendicular magnetic recording mediums are provided under the seed layer thereof with a magnetic film which is called a soft magnetic underlayer. Incidentally, the intermediate layer mentioned above is formed for the purpose of further exalting the characteristic properties of the magnetic recording medium. The seed layer is said to perform the function of correcting the crystalline orientations of the intermediate layer and the magnetic recording layer and, at the same time, controlling the shape of the magnetic crystals of the magnetic recording layer.

For the purpose of manufacturing a perpendicular magnetic recording medium that is possessed of excellent characteristic properties, it is important to enhance the crystalline orientation of the magnetic recording layer and impart a fine grain size to the individual crystals. In most of the perpendicular magnetic recording mediums, the magnetic recording layer thereof uses a Co-alloy material which has a hexagonal close-packed structure as its crystal structure. In the case of this nature, it is important that the crystal face (002) of the hexagonal close-packed structure be parallel with the face of the substrate, namely the crystal c axis [002] be oriented in the perpendicular direction with the least possible loss of order.

In order that the crystals of the magnetic recording layer may be oriented with the least possible loss of order, the intermediate layer of the perpendicular magnetic recording medium has been using ruthenium (Ru), which is a metal possessed of the hexagonal close-packed structure similar to the crystal structure of the alloy material for the conventional magnetic recording layer. As disclosed in Patent Document 1 mentioned below, for example, the magnetic recording medium excelling in crystalline orientation is obtained because the crystals of the magnetic recording medium are grown in an epitaxial form on the crystal face (002) of Ru.

In short, since the degree of orientation of the magnetic recording layer is enhanced by improving the degree of orientation of the crystal face (002) of the intermediate layer formed of Ru, the improvement of the degree of orientation of the crystal face (002) of Ru is necessary for the purpose of enhancing the recording density of the perpendicular magnetic recording medium. In the case of forming a layer of 100 at % of Ru element (hereinafter referred to as “Ru layer”) directly on the amorphous underlayer, however, it is necessary to give an increased film thickness to the Ru layer for the purpose of acquiring excellent crystalline orientation. When the magnetic recording medium is put to use for recording, therefore, the nonmagnetic Ru layer inevitably weakens the tension that is exerted on the underlayer which is a soft magnetic material by the magnetic flux emitted from the magnetic head. As disclosed in Patent Document 2 mentioned below, therefore, it has been customary heretofore to insert between the underlayer and the intermediate layer formed of Ru the seed layer which is oriented in the crystal face (111) of the face-centered cubic structure. The seed layer possessed of the face-centered cubic structure enables the intermediate layer of high crystalline orientation to be formed on the seed layer even when the seed layer has a film thickness of the order of 5 (nm). The layer formed of Ru on the seed layer which is possessed of a face-centered cubic structure, therefore, has high crystalline orientation even when it has a smaller film thickness than the layer of Ru directly formed on the underlayer.

As another method for imparting a fine grain diameter to the crystals of the intermediate layer and the magnetic recording layer on the seed layer, Non-Patent Document 1 mentioned below, for example, has a report regarding the formation of the intermediate layer with a granular structure that comprises a part of crystal grains of Ru or the like and a part of grain boundaries of oxide or the like which encircle the crystal grains mentioned above. According to this method, it is made possible to devise impartation of a fine grain diameter to the crystals because the part of grain boundaries of the intermediate layer can be enlarged by increasing the quantity of the oxide. Further, by forming on the intermediate layer the magnetic recording layer of such oxide as CoCrPt—SiO₂, it is made possible to form the individual layers from the intermediate layer to the magnetic recording layer severally in a granular structure so that the crystal grains in these layers may correspond perpendicularly. It expects the recording and reproducing property to be improved because these structures impart a fine grain diameter to the magnetic crystals, promote the segregation of oxide, and decrease noise.

As a method for improving the recording and reproducing property of the magnetic recording medium, it has been proposed to configure an antiferromagnetic exchange coupling structure, namely a switch connecting structure that results from forming plural magnetic recording layers, interposing a nonmagnetic bonding layer between the magnetic recording layers and coupling the magnetic recording layers antiferromagnetically. It is disclosed that this method improves the thermal stability of the magnetic recording layers. And, as this nonmagnetic bonding layer, Patent Document 3, for example, discloses use of such a nonmagnetic material as Ru or the like.

Further, for the purpose of enhancing the recording and reproducing property and the thermal fluctuation property of the magnetic recording medium, Patent Document 4, for example, discloses addition of such metal element as Ru to the CoCr-based magnetic recording medium.

Patent document 1: Japanese Unexamined Patent Publication No. 2001-6158

Patent document 2: Japanese Unexamined Patent Publication No. 2005-190517

Patent document 3: Japanese Unexamined Patent Publication No. 2007-273057

Patent document 4: Japanese Unexamined Patent Publication No. 2004-310910

Non-Patent literature 1: APPLIED PHYSICS LETTERS, vol. 89, pp. 162504

### DISCLOSURE OF THE INVENTION

Problem which the Invention Tries to Solve:

As described above, for the purpose of manufacturing a magnetic recording medium, layers formed of Ru element and layers containing Ru are used in large numbers in the laminated structure of the medium. These layers are possessed of an important functional and effect which is manifested in the property of electromagnetic transduction of the magnetic recording medium. When the contents of Ru element in the individual layers are varied, therefore, the differences of the contents of Ru element in the individual layers profoundly influence the property. According to the present inventor's study, in the magnetic recording medium which has an underlayer, a seed layer, an intermediate layer, a magnetic recording layer, and a protecting layer laminated on a substrate, the quantity of Ru used in the intermediate layer is the largest. It has been made clear that the recording and reproducing property of the magnetic recording medium can be improved by preventing the Ru element contained in the intermediate layer from diffusing in the magnetic recording layer. That is, because the Ru element used in the intermediate layer was diffused even to the magnetic recording layer and consequently the structures of the magnetic layers such as the antiferromagnetic switch connecting structure of the magnetic recording layer were disturbed, it is inferred that in the conventional magnetic recording medium, the reproducing property inherently possessed by the magnetic recording layer could not be manifested.

This invention initiated in view of the state of affairs mentioned above has an object of preventing the Ru element contained in the intermediate layer from diffusing into the magnetic recording layer and consequently improving the recording and reproducing property of the magnetic recording medium.

### Means for Solving the Problem:

This invention adopts the following configuration for the purpose of accomplishing the object mentioned above.

The first aspect of this invention is a perpendicular magnetic recording medium possessing at least a structure having an underlayer, a seed layer, a first intermediate layer, a second intermediate layer, a first magnetic recording layer, a second magnetic recording layer, and a protecting layer laminated sequentially on a nonmagnetic substrate, wherein the first intermediate layer is formed of an alloy of a composition having Ru element as an essential constituent, the second intermediate layer is formed of a CoCr alloy of a composition containing no Ru element, and the first magnetic recording layer and the second magnetic recording layer have sandwiched therebetween an alloy layer of a composition having Ru element as an essential constituent.

The second aspect of this invention is a perpendicular magnetic recording medium according to the first aspect of this invention, wherein the first magnetic recording medium is formed of a magnetic alloy containing Ru.

The third aspect of this invention is a perpendicular magnetic recording medium according to the first or the second aspect of this invention, wherein the second intermediate layer is a nonmagnetic layer of a granular structure, the granular structure comprises nonmagnetic particles containing Cr element at an atomic concentration in a range of 20 at %-50 at % and the oxide of at least one kind of element selected from the group consisting of Al, B, Bi, Ca, Cr, Fe, Hf, Mg, Mo, Nb, Ru, Si, Ta, Ti, W, and Zr, and the concentration of the oxide in the second intermediate layer is in a range of 8 mol %-20 mol %.

The fourth aspect of this invention is a perpendicular magnetic recording medium according to the third aspect of this invention, wherein the oxide in the second intermediate layer is at least one kind of oxide selected from among SiO₂, Cr₂O₃, and TiO₂.

The fifth aspect of this invention is a perpendicular magnetic recording medium according to any of the first to fourth aspects of this invention, wherein the film thickness of the second intermediate layer is in a range of 0.5 nm-10 nm.

The sixth aspect of this invention is a magnetic recording and reproducing apparatus provided with a perpendicular magnetic recording medium and a magnetic head for inducing the record reproduction of information in the perpendicular magnetic recording medium, wherein the perpendicular magnetic recording medium is any of the perpendicular magnetic recording mediums set forth in the first to fourth aspects of this invention.

### Effects of the Invention:

This invention enables stabilization of the laminated structure of a magnetic recording layer and, therefore, is capable of improving the recording and reproducing property of the magnetic recording medium and providing a perpendicular magnetic recording medium excelling in the property of high recording density.

### BRIEF DESCRIPTION OF THE DRAWINGS:

FIG. 1 is a cross section illustrating the perpendicular magnetic recording medium of this invention.

FIG. 2 is an oblique view illustrating the magnetic recording and reproducing apparatus of this invention.

### BEST MODE OF CARRYING OUT THE INVENTION

The details of this invention will be specifically described.

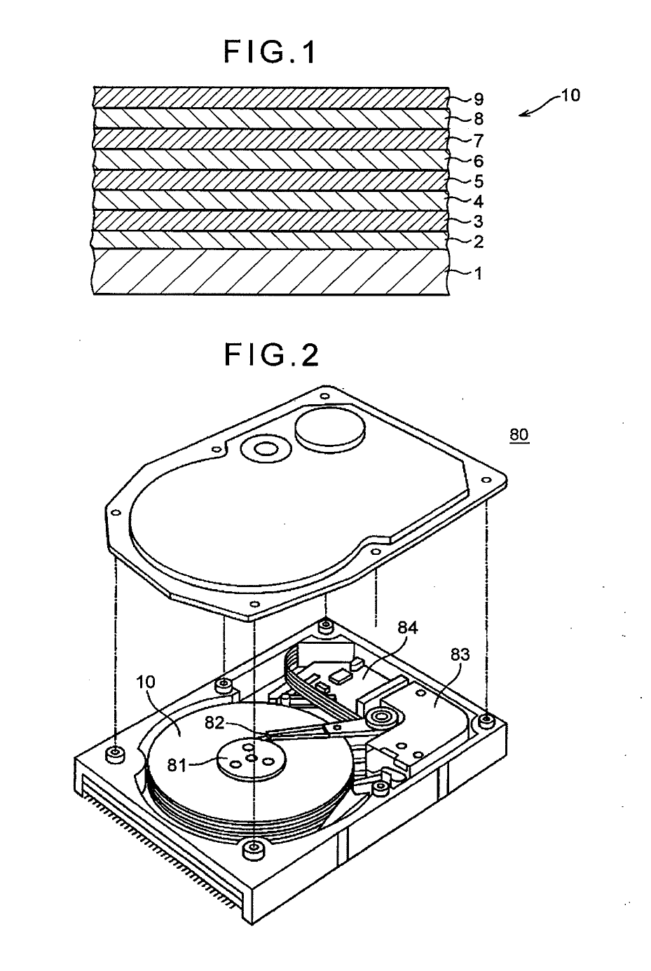

A perpendicular magnetic recording medium 10 of this invention, as illustrated in FIG. 1, is furnished with a structure that has laminated on a nonmagnetic substrate 1 at least a soft magnetic underlayer 2, a seed layer 3 for controlling the orientation of a film laid directly thereon, a first intermediate layer 4, a second intermediate layer 5, a first magnetic recording layer 6 having an axis of easy magnetization (c-axis of the crystal) oriented mainly perpendicularly to the substrate, a second magnetic recording layer 8, and a protecting layer 9. The first intermediate layer 4 is formed of an alloy having Ru as a main constituent, the second intermediate layer 5 is formed of a CoCr alloy containing no Ru element, and the first magnetic recording layer 6 and the second magnetic recording layer 8 have sandwiched therebetween an alloy layer 7 having Ru element as a main constituent. This perpendicular magnetic recording medium 10 can be applied to such new perpendicular magnetic recording mediums as ECC (exchange-coupled composite) medium, discrete track medium, pattern medium, and heat assist medium. The expression “having Ru as a main constituent” as used herein means the case of containing Ru element in a concentration of not less than 50 at % and the case of containing Ru element in a concentration of 100 at % as well.

As the nonmagnetic substrate for use in the perpendicular magnetic recording medium of this invention, any of nonmagnetic substrates such as Al-alloy substrates of Al—Mg alloys, for example, having Al element as a main constituent, ceramic substrates, and substrates formed of ordinary soda glass, alumino-silicate-based glass, amorphous glasses, silicon, titanium, sapphire, quartz, and various resins can be used. Among nonmagnetic substrates, Al-alloy substrates and glass substrates of crystallized glass and amorphous glass are used more often than not. In the case of glass substrates, mirror-polish substrates and substrates having surface roughness lowered to (Ra)<1 (Å) prove to be preferable. Even a substrate which contains a texture to a slight degree can be used in this invention.

In the process for manufacturing a magnetic disk, the first step usually consists of rinsing and drying the substrate. Similarly in this invention, with a view to ensuring adhesion of the individual layers, these layers are preferably rinsed and dried before they are combined. The rinsing is not limited to the rinsing with water but may include the rinsing by etching (reverse sputtering). Further, the substrate is not particularly limited in size.

Next, the individual layers of which the perpendicular magnetic recording medium of this invention is composed will be explained.

Many kinds of perpendicular magnetic recording mediums are provided with a soft magnetic underlayer, which performs the function of guiding a recording magnetic field from a magnetic head and efficiently applying the perpendicular component of the recording magnetic field to the magnetic recording layer while a signal is being recorded in the recording medium. As the material for the soft magnetic underlayer, any of the materials such as FeCo-based alloys, CoZrNb-based alloys, and CoTaZr-based alloys which are possessed of the so-called soft magnetic property can be used. The soft magnetic underlayer is particularly preferred to be in an amorphous structure. This is because the impartation of the amorphous structure to the soft magnetic underlayer prevents the magnetic recording medium from increasing the surface roughness Ra thereof, enables the amount of floatation of the head to decrease, and allows further addition to the recording density. Further, the laminated structure that is obtained by sandwiching a nonmagnetic thin film formed of such nonmagnetic material as Ru in an extremely small thickness between two soft magnetic layers and antiferromagnetically bonding these soft magnetic layers can be used as the soft magnetic underlayer in this invention. The total thickness of the underlayer is approximately 20 (nm)-120 (nm) and is properly decided by the balance between the recording and reproducing property and the overwrite (OW) property.

In this invention, the seed layer for controlling the orientation of a film laid directly thereon and the intermediate layer are disposed in this order on the soft magnetic underlayer. Further, in this invention, layers as intermediate layers are formed plurally and those layers are set to form a structure comprising the first intermediate layer and the second intermediate layer disposed in order from the substrate side.

In this invention, it is important that the above-mentioned seed layer should control the orientation of the crystals of the intermediate layers besides the wetting property of the materials of the intermediate layers. It is known that, when an amorphous material is used for the seed layer, the addition to the film thickness of the seed layer results in decreasing the surface undulation of the seed layer and improving the orientation of the crystals of the intermediate layers. Since the enhancement of the recording and reproducing property necessitates the fullest possible plunge of the magnetic flux from the magnetic head into the magnetic recording medium during the course of recording, however, the addition to the film thickness of the seed layer results in increasing the distance between the magnetic recording medium and the soft magnetic underlayer and weakening the plunge of the magnetic flux. Thus, the seed layer in this invention is preferred, even when the film thickness thereof is 5 nm or less, to use a material which is capable of retaining the orientation of the crystals of the intermediate layers. To be specific, the Cr—Ti, Cr—Mn, and Cr—Fe alloys and the Ta alloys which are known to be amorphous materials in the thin film region of about 10 nm, despite their compositions classified under the body-centered cubic structures in the space group, are preferably used as materials to form the seed layer.

The first intermediate layer in this invention is formed of Ru or a Ru alloy which possesses a hexagonal close-packed structure. Since the crystalline orientation of the magnetic recording layer which is superposed on the intermediate layer is substantially decided by the crystalline orientation of the intermediate layer, the control of the orientation of this intermediate layer is very important in terms of the manufacture of the perpendicular magnetic recording medium. When the wetting property of the material of the intermediate layer exhibited to the material of the seed layer is not fully satisfactory, the gas pressure existing at the time of depositing the intermediate layer is preferred to be low in the initial process of growth of the intermediate layer for the purpose of enhancing the crystalline orientation of the intermediate layer. When the deposition of the layer is continued in the presence of the low gas pressure, however, the plurality of crystals of the intermediate layer which is formed on the crystals of the seed layer undergo mutual coalescence during the growth of the layer. Since one crystal of the magnetic recording layer is epitaxially grown on the coarlesced crystals of the intermediate layer, the individual crystals of the magnetic recording medium are inevitably enlarged approximately to the diameter of the coalesced crystals of the intermediate layer. This invention, therefore, provides the perpendicular crystal recording medium with at least two intermediate layers, of which the first intermediate layer and the second intermediate layer are numbered on the basis of the order from the substrate side.

The second intermediate layer in this invention is made from CoCr alloy which possesses a hexagonal close-packed structure for the purpose of enabling the magnetic recording layer superposed thereon to be epitaxial-grown. What is important for this invention resides in avoiding use of Ru element in the second intermediate layer. That is, the second intermediate layer of this invention, besides performing the role of enabling epitaxial growth of the magnetic recording layer, discharges the role of preventing the Ru element contained in the first intermediate layer from diffusing in the magnetic recording layer and preventing this Ru element from disrupting the thin Ru-containing layer contained in the multi-layer structure of the magnetic recording layer.

By producing the second intermediate layer as a nonmagnetic layer of granular structure, producing the nonmagnetic grains forming the granular structure with a composition containing Cr element at an atomic concentration in a range of 25 at %-50 at %, producing the grain boundaries forming the granular structure with the oxide of at least one kind of element selected from the group consisting of Al, B, Bi, Ca, Cr, Fe, Hf, Mg, Mo, Nb, Ru, Si, Ta, Ti, W, and Zr, and fixing the concentration of the oxide in the second intermediate layer in a range of 8 mol %-20 mol %, this invention is enabled to exalt the property of epitaxial growth of the magnetic recording layer and ensure more reliable prevention of the Ru of the first intermediate layer from diffusing in the magnetic recording layer.

It is advantageous for the purpose of accomplishing the effects mentioned above to use as the oxide of the second intermediate layer of this invention at least one kind of oxide selected from among SiO₂, Cr₂O_{3,} and TiO₂ and fix the thickness of the second intermediate layer in a range of 0.5 nm-10 nm.

The high gas pressure laminating method gives rise to air gaps between crystal grains and, therefore, makes it possible to curb mutual coalescence of crystal grains. The laminating gas pressure is fixed preferably at or above 1.5 Pa and more preferably at or above 3 Pa. When crystal grains are encompassed with grain boundaries of oxide or nitride, not only mutual coalescence of crystal grains can be curbed but also fine division of crystal grains can be accomplished by enlarging the grain boundaries in width. In this invention, by curbing the mutual coalescence of crystal grains of the second intermediate layer, it is made possible to induce epitaxial growth of one crystal grain of the magnetic recording layer on one crystal grain of the intermediate layer, satisfy addition to the density of crystals of the magnetic recording layer and fine division of the crystal grains in diameter simultaneously, and prevent the Ru of the first intermediate layer from diffusing in the magnetic recording layer as well.

In this invention, the first intermediate layer and the second intermediate layer are preferred to be oriented in the crystal face (002) of the hexagonal close-packed structure. In many cases in the perpendicular magnetic recording medium, while the crystal structure of the magnetic recording layer of this medium assumes a hexagonal close-packed structure, it is important that the crystal face (002) should be parallel to the substrate face, namely the crystal c axis [002] should be arrayed in the perpendicular direction with the least possible turbulence. As a means for evaluating the outcome of this rule, the half-value breadth of the rocking curve can be used. By first evaluating the X-ray diffraction pattern of the film laminated on the substrate with the X-ray diffraction device, the crystal face parallel to the substrate face is analyzed. When the sample in the X-ray diffraction device happens to contain a film of hexagonal close-packed structure like the intermediate layer or the magnetic recording layer mentioned above, the diffraction peak that corresponds to the crystal face of a hexagonal close-packed structure is observed. In the case of the perpendicular magnetic recording medium using a Co-based alloy, since the c axis [002] of the hexagonal close-packed structure is oriented in the direction perpendicular to the substrate face, the peak that corresponds to the (002) face is observed consequently. Then, the optical system of the X-ray diffraction device is swung relative to the substrate face while the Bragg angle that diffracts this (002) face is retained intact. At this time, by plotting the diffraction intensity of the crystal face (002) relative to the angle of inclination of the optical system, one diffraction peak can be drawn. This diffraction peak is called a “rocking curve”. At this time, the rocking curve of a sharp shape is obtained when the crystal face (002) is paralleled with veritably high uniformity to the substrate face, whereas a broad curve is obtained when the direction of the crystal face (002) is widely dispersed. Thus, the half-value breadth Δ θ₅₀ of the rocking curve is often used as the index of conformity or unconformity of the crystalline orientation of the perpendicular magnetic recording medium.

By this invention, the perpendicular magnetic recording medium whose half-value breadth Δ θ₅₀ is small can be easily manufactured.

The magnetic recording medium literally is a layer that actually records a signal. As the materials for the magnetic recording layer, the thin films of such Co-based alloys as CoCr, CoCrPt, CoCrPtB, CoCrPtB—X, CoCrPtB—X—Y, CoCrPt—O, CoCrPtRu—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, CoCrPt—B₂O₃, CoCrPt—WO₂, CoCrPt—WO₃, and CoCrPt—RuO₂ are used more often than not. Incidentally, X and Y in the composition formulas of the Co-based alloys mentioned above denote mutually different components which are selected from among oxygen element and such metal oxides as SiO₂, Cr₂O3, TiO₂, ZrO₂, Nb₂O₅, Ta₂O₅, B₂O₃, WO₂, WO₃, and RuO₂. Particularly, when an oxide magnetic recording layer is used, the magnetic interaction of Co crystal grains is weakened and the noise is decreased because the oxide encircles the magnetic Co crystal grains and forms a granular structure. The crystal structure and the magnetic property of the magnetic recording layer eventually decide the record reproduction.

This invention is characterized in that magnetic recording layers are formed in a plural number and in that a layer having Ru element as its main component, namely, a switched connection controlling layer, in a thickness of 0.2 nm-2 nm, is sandwiched between the magnetic recording layers and thereby the switched connections between the magnetic recording layers are controlled. By the switched connection controlling layer mentioned above, the magnetic recording layers are enabled to enhance their thermal stability. The expression “having Ru as a main constituent” as used herein means, as described above, the case of containing Ru element in a concentration of not less than 50 at % and the case of containing Ru element in a concentration of 100 at % as well.

Further in this invention, the first magnetic recording layer is preferred to be formed of a magnetic alloy of a composition containing Ru element. This is because the feature that the magnetic grains contain the nonmagnetic element enables the saturated flux density Ms to be lowered and the demagnetizing field to be decreased. Further, since the crystal structure of Ru is a hexagonal close-packed structure similarly to the crystal structure of Co, the addition of Ru results in enabling the magnetic recording layer to retain the hexagonal close-packed structure easily and retain a high perpendicular anisotropy energy (Ku value). Further, what is particularly important in this invention consists in the point that the diffusion of the Ru element from the first intermediate layer can be appropriately controlled by having the first magnetic layer formed of a magnetic alloy of a composition containing Ru element. That is, by adding the Ru element to the magnetic recording layer, it is made possible to facilitate the retention of the hexagonal close-packed structure by the magnetic recording layer and inhibit the diffusion of the Ru element from the first intermediate layer.

In this invention, the quantity of Ru element to be added to the first magnetic recording medium is preferred to be about 1 at %-10 at %. Within this range of the quantity of addition, the quantity of Ru element to be added is decided by combining the record magnetic field of the magnetic head and other recording layers.

For the lamination of the individual layers mentioned above, the DC magnetron sputtering method or the RF sputtering method is usually adopted. Any bias selected from among the RF bias, DC bias, and pulse DC bias may be applied to the substrate and, as the sputtering gas, at least one member selected from the group consisting of O₂ gas, H₂O gas, H₂ gas, and N₂ gas may be used in addition to an inert gas. Though the sputtering gas pressure that is used in this case is properly decided so as to optimize the properties of the individual layers, it is generally controlled in an approximate range of 0.1 Pa-30 Pa. Further, the sputtering gas pressure is adjusted in view of the performance of the medium.

The protecting layer is intended to protect the medium from the damage caused by contact of the magnetic head with the medium. While carbon film, SiO₂ film, etc. are usable for this layer, the carbon film is used in many cases. Though the sputtering method, the plasma CVD method, etc. are usable for the formation of the protecting layer, the plasma CVD method is used more often than not in recent years. Besides, the magnetron plasma CVD method is usable. The film thickness of the protecting layer is about 1 nm-10 nm, preferably about 2 nm-6 nm, and more preferably 2 nm-4 nm.

FIG. 2 illustrates one example of a perpendicular magnetic recording and reproducing apparatus 80 which comprises the perpendicular magnetic recording medium described above. The magnetic recording and reproducing apparatus illustrated in FIG. 2 is composed of the magnetic recording medium 10 of the perpendicular magnetic recording medium, a medium driving part 81 for imparting rotary motion to the magnetic recording medium 10, a magnetic head 82 for inducing record reproduction of information in the magnetic recording medium 10, a head driving part 83 for causing the magnetic head 82 to be moved relative to the magnetic recording medium 10, and a record reproduction signal processing system 84.

The record reproduction signal processing system 84 is so adapted as to process a data input from the outside, forward a record signal to the magnetic head 82, process the reproduced signal from the magnetic head 82, and forward the resultant data to the outside.

Magnetic heads suitable for higher recording density which possess not only the MR (MagnetoResistTance) elements utilizing an anisotropic magnetoresistance effect (AMR) but also the GMR elements utilizing a giant magneto-resistance effect (GMR) and the TuMR elements utilizing a tunnel effect can be used as a reproducing element for the magnetic head 82 comprised in the magnetic recording and reproducing apparatus of this invention.

### EXAMPLES

The examples of this invention will be cited hereinbelow to explain this invention specifically.

### Example 1

A vacuum chamber having an HD-grade glass substrate set therein was evacuated in advance to a degree of vacuum of not more than 1.0×10⁻⁵ (Pa)

Then, on this substrate, a soft magnetic underlayer of 85Co10Ta5Zr was laminated by the sputtering method in an Ar atmosphere of a gas pressure of 0.6 Pa so as to give rise to a film of a thickness of 50 nm. The word “85Co10Ta5Zr” denotes an alloy composition containing Co element, Ta element, and Zr element respectively at concentrations of 85 at %, 10 at %, and 5 at %.

Then, a seed layer of 60Cr40Ti (an alloy composition containing Cr and Ti elements respectively at concentrations of 60 at % and 40 at %) was laminated in an Ar atmosphere of a gas pressure of 0.6 Pa to form a film of a thickness of 5 nm. Further, under the same condition of atmosphere, a first intermediate layer of 100 at % Ru element was laminated to form a film of a thickness of 100 nm. A second intermediate layer of a granular structure of 88 (60Co40Cr)-12TiO₂ was laminated in an Ar atmosphere of a gas pressure of 5 Pa to form a film of a thickness of 8 nm. Incidentally, the word “88 (60Co40Cr)-12TiO₂” denotes that an alloy formed of 60 at % of Co and 40 at % of Cr and the oxide TiO₂ are contained respectively at concentrations of 88 mol % and 12 mol % in the second intermediate layer. Similarly hereinafter, the composition of an alloy containing A element, B element, . . . C element respectively at atomic concentrations of a (at %) b (at %), . . . c (at %) will be denoted by the word “aAbB . . . cC.” Then, the composition of a layer containing compound X and compound Y respectively at molar percentages of x (mol %) and y (mol %) will be denoted by the word “xX-yY.”

A perpendicular magnetic recording medium of Example 1 was manufactured by further laminating a first magnetic recording layer of 92 (68Co10Cr16Pt6Ru)-8 (SiO₂), an Ru layer, a second magnetic recording layer of 64Co21Cr14Pt1B, and a C layer as a protecting layer in the order mentioned in respective thicknesses of 60 nm, 6 nm, 70 nm, and 30 nm.

The perpendicular magnetic recording medium of Example 1 was coated with lubricant and tested by using the Read-Write Analyzer 1632 and Spin Stand S1701MP made by GUZIK Co. of U.S.A. to evaluate the recording and reproducing property. Subsequently, the magnetostatic property of the medium was evaluated with the Kerr measuring device. Then, for the purpose of examining the crystalline orientation of the Co-based alloy in the magnetic recording medium, the rocking curve of the magnetic recording layer in the perpendicular magnetic recording medium of Example 1 was determined by using an X-ray diffraction instrument.

The values of high signal to noise ratio (SNR), coercive force (Hc), and half-value breadth Δ θ₅₀ of the perpendicular magnetic recording medium of Example 1 that are obtained on the basis of the results of the aforementioned property evaluation and determination performed on the perpendicular magnetic recording medium of Example 1 are shown in Table 1. These parameters are invariably indexes which are widely used in evaluating the electromagnetic transducing property of a perpendicular magnetic recording medium. Incidentally, 1 oersted (Oe) is approximately 79 A/m. Examples 2 - 19 and Comparative Examples 1 and 2:

The products of Examples 2-10 and Comparative Examples 1 and 2 were manufactured by following the same conditions of production of Example 1, excepting the alloy composition and film thickness of the second intermediate layer. Incidentally, the laminating conditions of the second intermediate layers in Examples 2-10 and Comparative Examples 1 and 2 were as shown in Table 1. Comparative Example 1 had no second intermediate layer laminated and Comparative Example 2 had no Ru layer sandwiched between the first magnetic recording layer and the second magnetic recording layer.

The products of these examples and comparative examples were each subjected to evaluation of recording and reproducing property and magnetostatic property and determination of the rocking curve of a magnetic recording layer under the same conditions as those used for the perpendicular magnetic layer of Example 1. The results of the determination of high signal to noise ratio (SNR), coercive force (Hc), and half-value breadth Δ θ₅₀ of the examples and the comparative examples are shown in Table 1.

| | Second intermediate layer | | | | |
|---|---|---|---|---|---|
| | | Film thick- | SNR | Hc | Δ θ₅₀ |
| | Composition | ness (nm) | (dB) | (Oe) | (deg) |
| Example 1 | 88 (60Co40Cr)—12TiO₂ | 8 | 18.1 | 4500 | 2.79 |
| Example 2 | 81 (78Co22Cr)—19TiO₂ | 4 | 18.5 | 4630 | 2.78 |
| Example 3 | 81 (75Co25Cr)—19TiO₂ | 5 | 18.5 | 4520 | 2.81 |
| Example 4 | 89 (60Co40Cr)—11SiO₂ | 5 | 18.0 | 4500 | 2.80 |
| Example 5 | 88 (70Co30Cr)—12Cr₂O₂ | 5 | 18.0 | 4580 | 2.79 |
| Example 6 | 90 (60Co40Cr)—10WO₂ | 9 | 17.9 | 4150 | 2.81 |
| Example 7 | 89 (60Co40Cr)—11WO₂ | 3 | 17.8 | 4390 | 2.80 |
| Example 8 | 88 (60Co30Cr10Pt)—12TiO₂ | 2 | 18.3 | 4690 | 2.78 |
| Example 9 | 88 (60Co10Ni30Cr)—12TiO₂ | 3 | 18.2 | 4530 | 2.79 |
| Example 10 | 88 (60Co38Cr2Ta)—12TiO₂ | 3 | 18.1 | 4620 | 2.79 |
| Comparative | No second | 0 | 17.4 | 4690 | 2.79 |
| Example 1 | intermediate layer | | | | |
| Comparative | 88 (60Co40Cr)—12TiO₂ | 12 | 17.6 | 3750 | 3.02 |
| Example 2 | | | | | |

It is clear from Table 1 that the products of Examples 6 and 7 are higher respectively by 0. 5 and 0.4 than the product of Comparative Example 1 in terms of the SNR property which is the most important index for a magnetic recording medium. It is also clear that the magnetic recording mediums of these examples invariably have high values of Hc and low values of half-value breadth Δ θ₅₀.

1. A perpendicular magnetic recording medium comprising at least a structure having an underlayer, a seed layer, a first intermediate layer, a second intermediate layer, a first magnetic recording layer, a second magnetic recording layer and a protecting layer laminated sequentially on a nonmagnetic substrate,
the first intermediate layer being formed of an alloy of a composition having Ru element as an essential constituent, and
the second intermediate layer being formed of a CoCr alloy of a composition containing no Ru element,
wherein an alloy layer of a composition having Ru element as an essential constituent is sandwiched between the first magnetic recording layer and the second magnetic recording layer.

2. A perpendicular magnetic recording medium according to claim 1, wherein the first magnetic recording medium is formed of a magnetic alloy containing Ru element.

3. A perpendicular magnetic recording medium according to claim 1,
wherein the second intermediate layer is a nonmagnetic layer of a granular structure, the granular structure comprises nonmagnetic particles containing Cr element at an atomic concentration in a range of 20 at %-50 at % and the oxide of at least one kind of element selected from the group consisting of Al, B, Bi, Ca, Cr, Fe, Hf, Mg, Mo, Nb, Ru, Si, Ta, Ti, W, and Zr, and the concentration of the oxide in the second intermediate layer is in a range of 8 mol %-20 mol %.

4. A perpendicular magnetic recording medium according to claim 3, wherein the oxide in the second intermediate layer is at least one kind of oxide selected from among SiO₂, Cr₂O₃, and TiO₂.

5. A perpendicular magnetic recording medium according to claim 1,
wherein the film thickness of the second intermediate layer is in a range of 0.5 nm-10 nm.

6. A magnetic recording and reproducing apparatus provided with a perpendicular magnetic recording medium and a magnetic head for inducing the record reproduction of information in the perpendicular magnetic recording medium,
wherein the perpendicular magnetic recording medium is any of the perpendicular magnetic recording mediums set forth in claim 1.
